(19) United States
(12) Patent Application Publication
(10) Pub. No.: US 2009/0079532 A1
(43) Pub. Date: Mar. 26, 2009

(54) Composite Magnetic Core Construction

(76) Inventor: Norman F. Muelleman, Cary, IL (US)

Correspondence Address: Wayne L. Tang, Esq;Nixon Peabody LLP, Suite 4800, 161 North Clark Street, Chicago, IL, 60601, US

(21) Appl. No.: 12/233,167

(22) Filed: Sep. 18, 2008

Related U.S. Application Data
(60) Provisional application No. 12/228,068, filed on Sep. 20, 2007.

(51) Int. Cl. H01F 27/24; H01F 3/10

(52) U.S. Cl. 336/234; 29/602.1

(57) ABSTRACT

A composite magnetic core construction to replace conventional magnetic core construction for transformers, inductors, motors, generators, relays, solenoids, and delay lines. The composite core consists of a principal magnetic core section and an alternate magnetic core section. An example for constructing cores with high residual inductance above saturation is a 50% principal magnetics to a 50% alternate magnetics ratio. The alternate magnetics needs to be more economical per pound than the principal magnetics. The alternate magnetics also needs to have the same effective magnetic flux density saturation as the principal magnetics. When these two requirements are met, then the composite core will have the same power density (Watts/lb) as the original conventional core, but will be less expensive.

### CROSS REFERENCE TO RELATED APPLICATION

This application claims the benefit of the U.S. Provisional Application No. 60/994,561, filed on Sep. 20, 2007, which is hereby incorporated by reference in its entirety.

### FIELD OF INVENTION

The present invention relates generally to magnetic devices and more specifically to Electro-magnetic (E-M) and permanent magnetic (PM) devices whose magnetic cores can be alternatively constructed with composite magnetic materials.

### BACKGROUND OF THE INVENTION

### Introduction to Practical E-M Design

The term “E-M devices” includes, but is not limited to: passive devices such as transformers, inductors, and delay lines; and electromechanical devices such as motors, generators, relays, solenoids, and the “rail gun.” Some of these E-M devices also include permanent magnetic (PM) components that work synergistically with the E-M components to hold, lift, or torque magnetic susceptible material.

Transformers, motors, generators, inductors, and solenoids are built with four types of Electro-magnetic cores: tape wound cores (TWCs), laminated cores (Lams), solid block cores (SBCs), and air core (AiC). Tape wound cores, TWCs, are made of lamination steel having a thickness typically from 2.0 mils to 24 mils or more and tape wound onto circular or rectangular hubs forming either circular TWCs (circular doughnut shapes) known as toroids, or rectangular shapes (rectangular doughnuts). Tape wound cores are used exclusively for transformers and inductors.

Laminated cores are either grain oriented (GO), non-grain oriented (NGO), or cold rolled motor lamination (CRML) steel, flattened, and stamped into desired electromagnetic shapes. Laminations used to construct transformers are usually “E” and “I” shapes or “U” and “I” shapes. FIG. 4 shows a typical “E” and “I” lamination. Transformer “E” and “I” shapes, as well as “U” and “I” core shapes, are generically referred to as “square core”. Motors and generators have the flattened lamination steel stamped into the special circular shapes for stators and rotors as required by the motor or generator design. FIG. 8 shows a typical stator and rotor lamination. The lamination steel used in three phase power transformers is flattened and stamped into rectangular sheets. The flattened, stamped, laminar steels are generically referred to as “Lams.”

Solid block cores (SBCs) are usually pressed, molded, and sintered powdered ferrite or powdered iron magnetic materials which have mechanical properties similar to ceramics. The molding operation for ferrites and powdered iron enables them to take on special shapes described by the mold's geometry.

Air cores, AiCs, are either hollow or otherwise magnetically inert core materials such as various plastics, whose relative magnetic permeability (μ_{R}) is equal to 1.

All materials are characterized by their ability to accommodate the magnetic flux density (B) induced by the magnetic force field (AT, Ampere*Turn) permeating their space. This magnetic accommodation ability is known as the material's magnetic permeability (t).

The maximum operating electrical power for all these devices is determined by the maximum operating voltage rating (V_{Mx}(f)) at operating frequency (f), at which the radially (r) distributed, maximum flux density (B_{Mx}(r)) is equal to the magnetic material's saturated magnetic flux density (Bsat) throughout all sections of the magnetic core. (B_{Mx}(r)=Bsat) A magnetic material's maximum magnetic flux density, Bsat, is the maximum number of magnetic flux (C_{Mx}(R) lines per unit cross sectional area (A_{C}) of magnetic material that the material will support without magnetically saturating. Magnetic force fields, AT, that try to cause the magnetic material's flux density, B, to exceed Bsat will cause the magnetic material to go into magnetic saturation and try to reduce the magnetic core's relative magnetic permeability, μ_{R}, to 1, the relative permeability of an air core. The magnetic device's maximum operating voltage, V_{Mx}(f), occurs when the operating voltage (V(f)) causes the maximum magnetizing current (I_{Mx}(f)) to induce into the magnetic device the maximum magnetic flux (Φ_{Mx}(f)) which causes the radially distributed magnetic flux density, B_{Mx}(r), to reach Bsat, along the entire radial length of the device's radial cross section.

Magnetic materials used in magnetic core constructions come in various grades characterized by their magnetic and heat dissipation parameters. Generally, the higher the Bsat rating of a magnetic material the more costly it is to produce. Conjointly, the higher the Bsat rating of a magnetic material the higher the permeability, μ, of the magnetic material and the lower its heat dissipation. Thus, magnetic materials with the highest Bsat, highest permeability, A, and lowest heat dissipation have the highest cost.

Conventional transformers, motors, and generators operating at the power line frequencies, 50, 60, or 400 Hz, have always used a uniform grade of magnetic material throughout the core. That is, the core is 100% constructed of magnetic material of the same grade and the same chemistry. Their magnetic material is either GO, NGO, or CRML and graded by an “M” number. Likewise, ferrite and powdered iron magnetic materials used to construct magnetic cores for high frequency transformers, inductors, motors, or generators are also a uniform magnetic composition throughout the core.

Lamination steel, because of its high inductance, low cost, and low heat dissipation at the power line frequencies has been the exclusive magnetic material used to construct power line operating transformers, motors, and generators. About 10 to 20 billion pounds of lamination steel are annually consumed worldwide in the construction of these power line operating components.

Lamination steel is a thin sheet steel ranging in thickness from 0.002 inches to 0.024 inches or more. Lamination steel comes from the steel mills as these thin sheets, up to 60 inches wide, tape wound on a mandrel forming 10,000 pound spools.

The chemistry of lamination steel varies with the grade and annealing. Magnetic steels are graded with an “M” number that is used to designate the hysteretic heat dissipation, times ten, in Watts per pound. For instance, M47 magnetic material is rated as a 4.7 Watts per pound hysteretic heat dissipation.

Basically, lamination steel is very low carbon steel. Additives such as silicon, manganese, nickel and cobalt may be added to improve the magnetic properties and lower the steel's hysteretic heat dissipation. A high grade magnetic material such as M6 (0.6 Watts per pound) nominally has 3% silicon added to it. Lamination steel grade M6 is a grain oriented, GO, magnetic material that has induction properties, usually 20% to 30% better than the non-grain oriented, NGO, magnetic materials. The magnetic material grades M2 through M15 are GO, the magnetic material grades from M19 to M47 are NGO, and the magnetic material grades from M50 and higher are CRML.

The higher induction grain oriented, GO, magnetic materials are usually milled thinner than the non-grain oriented, NGO, magnetic materials. GO magnetic material M6 is usually milled at 0.014 inch thickness. Magnetic properties improve when GO magnetic material is milled thinner. The better grades of GO magnetic material, usually referred to as M2 through M5, are milled to 0.008 inch thickness or less. Milling GO magnetic material thinner improves its magnetic properties and lessens its heat dissipation.

The non-grain oriented, NGO, magnetic materials, M19 through M47, and the cold rolled motor lamination, CRML, magnetic materials M50-M75, usually come in a standard thickness, 0.0185 inches. Thinner NGO and CRML material can be obtained by special orders to the mill.

The market demand on the high grade lamination steels has been precipitated by the emergence of India and China as major consumers of lamination steels for infrastructure and consumer products. They have created a market demand that has put upward pressure on the price and supply of lamination steels, particularly the high quality lamination steels such as GO: M6; NGO: M19; and CRML: M50. Over the past 6 to 8 years, market demand has about tripled the price of M6, and M19 and M50 are following suit. Other NGO lamination steel grades such as M27 through M47 have been deemed less desirable and have been discontinued in a steel mill's product run, replaced instead by exclusively producing the high quality magnetic steels so as to satisfy the market demand. Consequently, the NGO lamination steel grades M27 through M47 are no longer found stocked on the shelves of the various stamped lamination suppliers.

Until recently GO: M6 was the most popular choice for lamination steel core construction because it had the best magnetic properties and lowest heat dissipation for the size and cost. Transformers were designed exclusively with M6 throughout. Then as market demand exceeded supply, M6 got to be more expensive, and NGO: M19, and then CRML: M50 lamination steels got to be better economic choices for transformer magnetic cores than M6. However, like the M6 designs, the M19 and M50 were used 100% uniformly throughout the core. With motors and generators, the M50 emerged as the preferred alternate to M6 and is also used 100% throughout the motor or generator's magnetic core.

The traditional automatic core stacking equipment for lams prohibited inserting magnetic materials of different thicknesses. The automatic equipment for stacking lams has been slowly replaced by butt stacking and welding. The welding occurs along the “E” and “I” seam and mechanically locks the lamination layers together. Butt stacking and welding now allows for the efficient insertion of lamination materials of different thicknesses into the lamination stack.

Over the past 10 years, the steel mills have improved the magnetic and heat dissipation quality of ungapped non-grain oriented, NGO, and cold rolled motor lamination CRML steel. For instance, NGO: M47 can be stamped and annealed to have magnetic and heat dissipation properties closer to NGO: 19. Likewise, CRML: M50 can also be stamped and annealed to have magnetic and heat dissipation properties even closer to that of NGO: 19. And NGO: M19 properties have been improved closer to GO: M6. Although improved mill processing has brought the magnetic and heat properties of ungapped NGO: M19 and CRML: 50 closer together, ungapped GO: M6 has a 20% better Bsat and permeability than NGO: M19; and CRML: M50 and 2.7 times less heat dissipation. Consequently, GO: M6 and its near relatives, like GO: M8, are still the preferred electrical steel in the market and consequently have the highest market demand which exacts premium pricing, about 2.7 times that of CRML: M50.

Product cost considerations, particularly with lamination steels, have been driving the need for alternate acceptable magnetic materials of a lower cost. Besides alternate acceptable magnetic materials, alternate core constructions can also reduce product cost.

This specification describes two composite core constructions that can reduce magnetic core cost. One composite construction integrates low cost magnetics with high permeability, A, above its magnetic saturation, Bsat, with conventional magnetics. The other composite core construction integrates low cost magnetics of higher heat dissipation but with comparable magnetic qualities, with conventional magnetics with lower heat dissipation but similar magnetic qualities.

### SUMMARY

According to one example, a composite magnetic permeable core for an electro-magnetic device is disclosed. The composite core includes a principal magnetic material having a first magnetic flux density saturation value. An alternate, different magnetic material having a second magnetic flux density saturation value lower than the first magnetic flux density saturation is provided. The core is operated at the first magnetic flux density saturation value.

According to another example, a method of forming a composite magnetic permeable core for an electromagnetic device is disclosed. A principal magnetic material having a first magnetic flux density saturation value is selected. An alternate, different magnetic material having a second magnetic flux density saturation value lower than the first magnetic flux density saturation is selected. The principal and alternate magnetic material are joined such that the core is operated at the first magnetic flux density saturation value.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is an isometric view of a conventional magnetic tape wound core (TWC).

FIG. 2 is an isometric view of a composite, inline, concentric tape wound core.

FIG. 3 is an isometric view of composite, stacked, concentric tape wound core.

FIG. 4 is an isometric view of a prior art “E” lamination and an “I” lamination.

FIG. 5 is an isometric view of a conventional, interleaved lamination El core.

FIG. 6 is an isometric view of a composite, interleaved lamination El core.

FIG. 7 is an isometric view of a composite, butt-stacked lamination El core.

FIG. 8 is an isometric view of a prior art motor-generator stator and rotor lamination.

FIG. 9 is an isometric view of a conventional, laminar, motor-generator assembly.

FIG. 10 is an isometric view of a composite, sectional, laminar, motor-generator assembly.

FIG. 11 is a graph showing the magnetizing current, Im(f), response to the magnetizing voltage, Vm(f), for a principal magnetics' core, an alternate magnetics' core, and the composite core formed by each.

### DESCRIPTION OF ILLUSTRATIVE EMBODIMENTS

One preferred embodiment is a composite core construction consisting of at least two different magnetic materials, possibly of different thicknesses, designed to reduce the core's construction cost while maintaining the same size and weight for the same or higher maximum operating voltage, V_{Mx}(f). This means that the composite core will have the same or higher power density (PD, Watts/pound) as the conventional core it is intended to replace.

### Composite Core Construction

### Introduction

Composite core construction is the integration of an appropriate alternate magnetic material with the magnetic core's principal magnetic material thereby creating an effective new core construction. Composite core construction may increase, decrease, or remain the same, the new magnetic core's effective cost (cost_{eff}), effective power density (PD_{eff}, Watts/pound), effective permeability (∥_{eff}), or effective magnetic flux density saturation (Bsat_{eff}). The preferred embodiment decreases the core's effective cost, cost_{eff}, while maintaining or increasing the core's effective power density, PD_{eff}.

The magnetic core's principal magnetic material may be the core material that the core was originally designed for. The principal magnetic material may also be the main magnetic material as a result of a new combination of magnetic materials. In either case, the principal or main magnetic material dominates the core's electrical and magnetic properties and cost. The principal magnetic material is characterized by high magnetic permeability (μₚ) and high magnetic flux density saturation (Bsatₚ). Above its magnetic flux density saturation, Bsatₚ, the principal magnetic material is in hard magnetic saturation. In hard magnetic saturation, the magnetizing current, Im(f), increases very quickly for small increases in magnetizing voltage, Vm(f), above the maximum magnetizing voltage, V_{Mx}(f). Magnetic devices in hard magnetic saturation can trip circuit protection devices such as circuit breakers or fuses.

The alternate magnetic material, which may consist of more than one magnetic material, is integrated into the core's principal magnetic material so as to effectively modify the composite core's cost, cost_{eff}, power density, PD_{eff}, permeability, μ_{eff}, and magnetic flux density saturation, Bsat_{eff}. Two types of alternate magnetic materials are useful for constructing composite cores. The first type has a large residual inductance when the alternate magnetic material is magnetically operated above its magnetic flux density saturation (Bsat_{A}). The alternate magnetic material then takes on effective magnetic flux density saturation (Bsat_{effA}). The residual inductance allows the alternate magnetic material's effective magnetic flux density, Bsat_{effA}, to match or exceed the principle magnetic material's flux density saturation, Bsat_{P} The residual inductance inhibits large changes in magnetizing current, Im(f), for small changes in magnetizing voltage, Vm(f), above the maximum magnetizing voltage, V_{Mx}(f). The residual inductance thereby keeps circuit protection devices from early tripping when the magnetizing voltage, Vm(f), exceeds the maximum magnetizing voltage, V_{Mx}(f). The alternate magnetic material usually has a lower permeability (μA) than the principal magnetic material's permeability, μ_{P}. Also, the alternate magnetic material usually has a higher power dissipation but consequently a lower cost. While the higher power dissipation may increase core heating a few degrees, it may be negligible compared to the heating of the magnetic wiring at full load current.

The second type of alternate magnetic material is electrically and magnetically equivalent to the principal magnetics but has a higher dissipation factor and consequently costs less.

### Principal Magnetics

For tape wound cores, (TWCs), or Lams, a typical principal core material may be one of these lamination steel grades: GO: M6; NGO: M19; or, CRML: M50. The mills have upgraded their processing capability such that the magnetic permeabilities, A, and magnetic flux density saturation, Bsat, of gapped GO: M6; NGO: M19; or, CRML: M50, are nearly identical. These grades have high Bsat and permeability, t. Although ungapped GO: M6 has a higher permeability, A, and magnetic flux density saturation, Bsat, than NGO: M19; or,

CRML: M50, magnetic core gapping, which is intrinsic in laminated cores and tape wound cut cores, narrows the magnetic differences. The only significant difference between these grades is their respective power dissipations. Improved mill processing produces CRML M50 with about the same power dissipation as NGO M19. However, the power dissipation of GO M6 is still about a factor of 2.7 lower than the power dissipation of M19 or M50.

Amorphous metal may be another principal magnetic material alternative to lamination steel.

For ferrite SBCs, a typical principal core material may be Fair-Rite's Type 77, TDK Type PC40, or TSC Type 7070, or other ferrite manufacturer's equivalent, each having acceptable permeability, Bsat, and cost.

### Alternate Magnetics

The two types of alternate magnetics require different magnetic materials. The first type which utilizes the large residual inductance above its saturation region, Bsat_{A}, is best served by steel Lams made of: NGO: M36 or M47; or higher order CRML. The second type uses steel Lams that are electrically and magnetically similar to the principal magnetics but have a higher power dissipation. Candidate steel Lams for the second type of alternate magnetics are: NGO: M19 or other comparable NGOs and CRML: M50 and other comparable CRMLs.

Air core is another alternate magnetic material to be considered for SBC core applications and some TWC or Lam applications.

To achieve one of the preferred embodiments, the alternate magnetic material must satisfy two requirements. First, the alternate magnetic material must have a cost per pound less than the principal magnetic material with acceptable magnetic parameters. Second, the alternate magnetic material must have an effective magnetic saturation flux density, Bsat_{effA}, similar to or greater than the principal magnetic material's magnetic saturation flux density, Bsat_{P}. Laminated magnetics or cut cores narrow the differences between the effective magnetic saturation flux densities.

Throughout this specification and as a matter of convenient reference, the construction of composite cores will be presented as a nominal 50/50 ratio. That is, all composite cores will nominally have their cross sections apportioned to 50% principal magnetics and 50% alternate magnetics. The specification is not intended to limit composite core construction to the 50/50 ratio. All other ratios may be considered and used for implementing this specification.

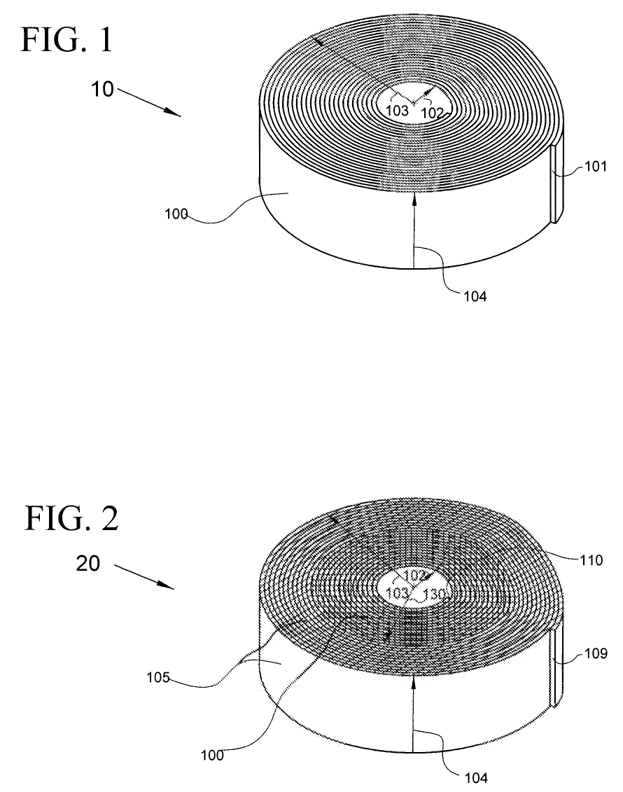

FIG. 1 shows a conventional lamination steel TWC 10, with uniform core construction. The magnetic material 100 may be M6, M19, M50 or some other appropriate magnetic material. The magnetic material's thickness (Th) 101 is between 2.0 mils and 24 mils or greater depending on the transformer's size and steel gauge requirements. The TWC core 10 is formed by tape winding lamination steel 100, with a constant core width (w_{Fe}) 104, on a hub with a radius of inner diameter (r_{ID}) 102. The tape winding stops and is usually terminated by a spot weld when the winding reaches the radius of outer diameter (r_{OD}) 103.

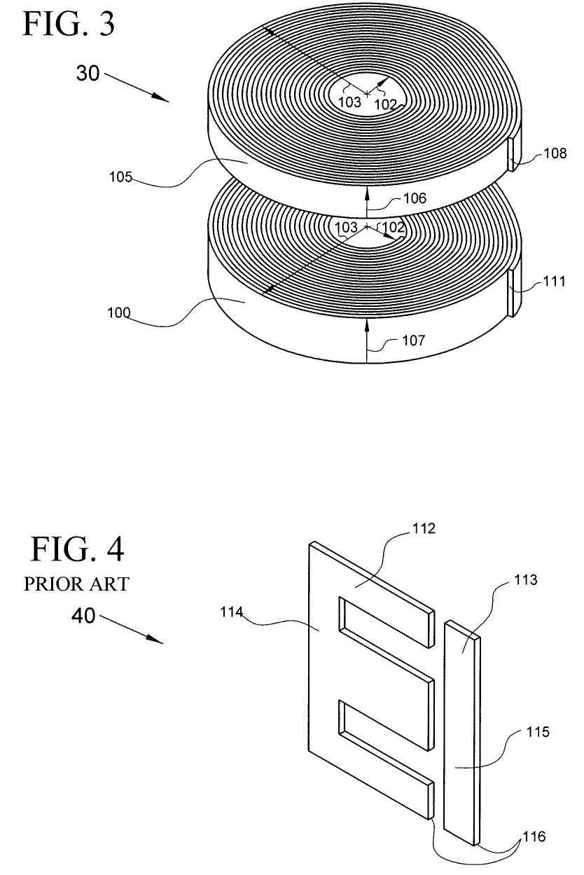

FIGS. 2 and 3 show two types of lamination steel TWCs 20 and 30 respectively, with different composite core constructions. These composite core constructions 20 and 30 illustrate reduced cost core constructions of the same power density as conventional core 10 in FIG. 1. The composite TWC core 20, shown in FIG. 2, is formed by tape winding the principal magnetic lamination steel 100, (shown marked as a grid), with a constant core width, w_{Fe}, 104, on a hub with a radius of inner diameter, r_{ID}, 102, which is the same radius of inner diameter, r_{ID}, as 102 in FIG. 1. The tape winding stops and is usually terminated by a spot weld when the winding reaches the radius of outer diameter, r_{OD}, 103 that is 50% of the composite core's radial length. The composite core's radial length is the differential of its radius of outer diameter, r_{OD}, 103, and radius of inner diameter, r_{ID}, 102. The radius of outer diameter, r_{OD}, 103 in FIG. 2, is the same radius of outer diameter, r_{OD}, 103 in FIG. 1. The composite core's principal magnetic material, 100, is the same as the magnetic material 100 in FIG. 1.

FIG. 2 shows the composite lamination steel TWC 20, formed by the sequentially tape winding alternate magnetic material 105 (shown cross-hatched) to the principal magnetic material 100 (shown marked as a grid). Alternate material 105 may be started with a spot weld to the principal magnetic material at radius 130 and then tape wound around the principal magnetic material 100 as the hub. Tape winding the alternate magnetic material 105 stops, and is usually terminated by a spot weld, when the winding reaches the radius of outer diameter, r_{OD}, 103. Achieving a 50/50 ratio of principal magnetic material 100 to alternate magnetic material 105 requires that the composite core's cross section contain 50% principal magnetic material 100 and 50% alternate magnetic material 105. The lower cost alternate magnetic material 105 economically best serves the composite construction by occupying the core's outer section of magnetics while the principal magnetics 100 occupies the core's inner section. However, the principal and alternate magnetics may interchange their occupational sections.

The thickness 110 of the principal magnetic material used in the composite TWC 20 in FIG. 2, may or may not be the same thickness 101 as the material used in the conventional TWC 10 in FIG. 1. In FIG. 2, the magnetic materials used in the composite TWC 20 may be of a different gauge but the best core construction for applying the magnetic winding occurs when they are of the same core width, w_{Fe}, 104.

The composite TWC core 20 in FIG. 2, is the same size as the conventional TWC core 10 in FIG. 1, and has the same maximum operating voltage, V_{Mx}(f). The r_{ID}, 102, r_{OD}, 103 and w_{Fe}, 104, of the composite TWC core 20 in FIG. 2, are identical to the r_{ID}, 102, r_{OD}, 103, and w_{Fe}, 104, of the conventional TWC 10 in FIG. 1; hence, the volume of composite TWC core 20 in FIG. 2 is the same as the volume of the conventional TWC 10 in FIG. 1. Thus, the composite core construction shown by TWC 20 in FIG. 2, has the same power density (PD), as the conventional TWC 10 shown in FIG. 1.

FIG. 3 shows a composite tape wound core 30, formed by concentrically layering two TWCs of different lamination steel magnetics. Each TWC has the same radius of inner diameter, r_{ID}, 102, and same radius of outer diameter, r_{OD}, 103. However, the core widths, w_{Fe}, are different as required by the core's required composition. The principal magnetic material's core width, w_{Fe}, is designated by element 107 and the alternate magnetic material's core width, w_{Fe}, is designated as element 106. To achieve a 50/50 principal to alternate magnetic material ratio, the width of the alternate magnetic material 106, should be 50% of the effective width of the composite core (w_{Feeff}). That leaves 50% of the total magnetic material for the principal magnetic material 107. If the core widths, w_{Fe}, 106 and 107 are added to the core width 104 of the conventional TWC 10 in FIG. 1, and the composite TWC 20 in FIG. 2, then the three cores 10, 20, and 30, shown in FIGS. 1, 2 and 3, are physically and magnetically identical and could be used interchangeably. The thickness 111, of the principal magnetic material 107 used in the TWC 30 is usually the same as the thickness 101 in the TWC 10 in FIG. 1, or the thickness 110 in the TWC 20 in FIG. 2; or the thickness 111 could be different than either. Likewise, the thickness 108 of the alternate magnetic material 105 used in the TWC 30 is usually the same as the thickness 109 in TWC 20 in FIG. 2; or the thickness 108 could be different than the thickness 109.

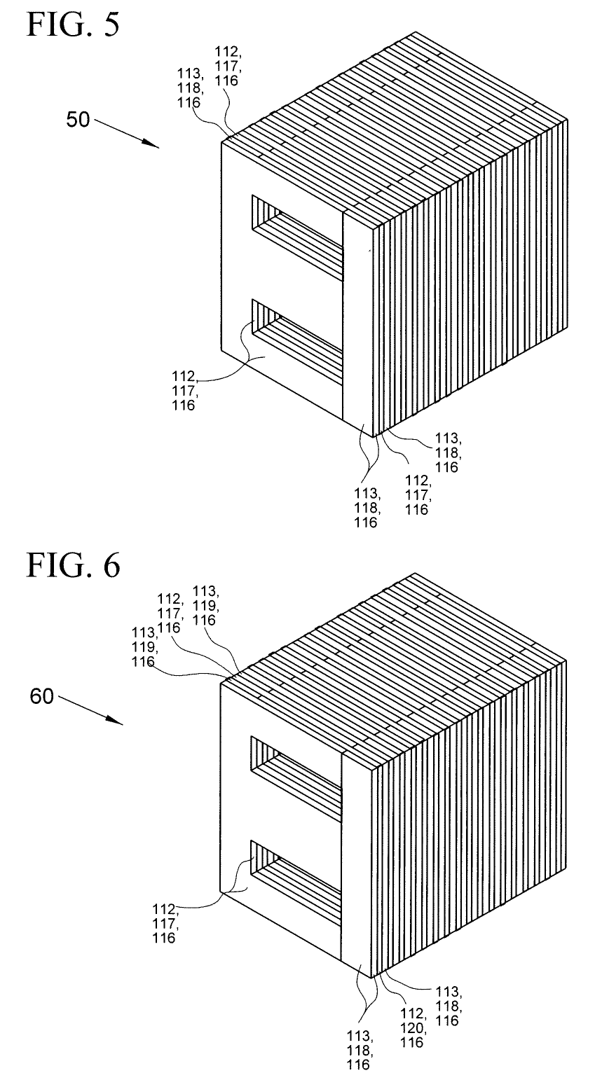

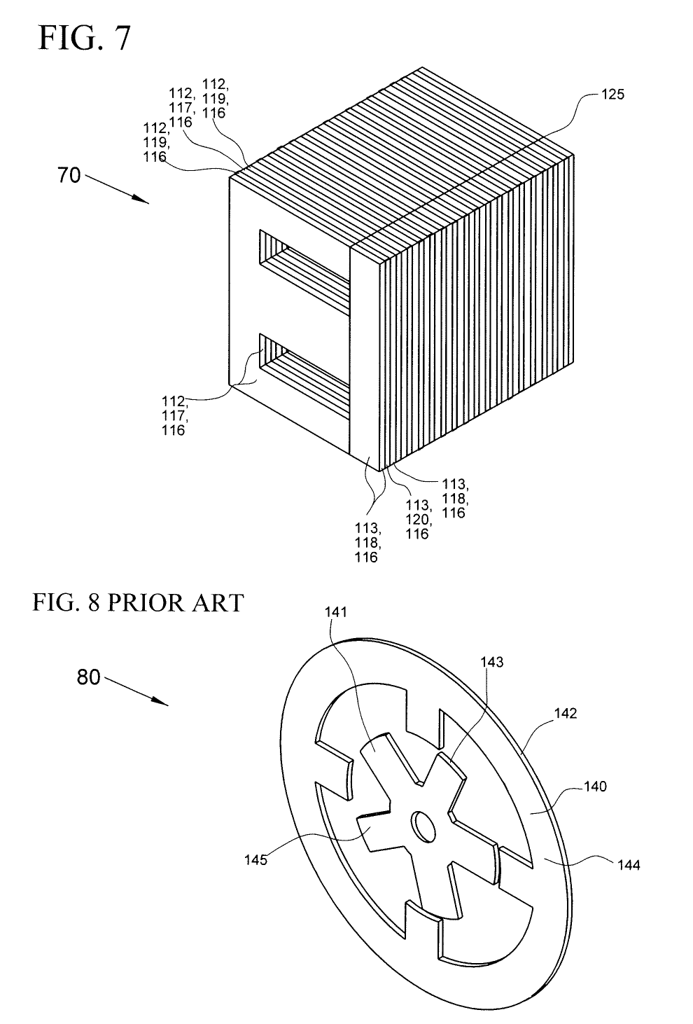

FIG. 4 shows a single stamped “E” shaped element 112, and a stamped “I” shaped element 113, as part of a lamination 40 that would be used to construct the conventional “E-I” transformer core 50 shown in FIG. 5, the composite E-I transformer core 60 shown in FIG. 6, and the composite E-I transformer core 70 shown in FIG. 7. Both the “E” shaped element 112, and the “I” shaped element 113 in the lamination 40 have the same thickness 116 that could vary from 2 mils to 24 mils or greater. The magnetic material for the “E” shaped element 114, and the “I” shaped element 115, could be either GO: M6; NGO: M19 or M47; CRML: M50, or some other appropriate grade.

FIG. 5, is a conventional “E-I” transformer core 50 wholly and uniformly constructed by stacking and interleaving conventional stamped “E” shaped elements 112 and “I” shaped element 113 in magnetic Lams 40 in FIG. 4. The magnetic material 117 for the “E” shaped elements 112, and the magnetic material 118 for the “I” shaped elements 113, could be GO: M6: M19; NGO: M19 or M47; CRML: M50, or some other appropriate grade but the magnetic material for both pieces are usually the same grade.

FIG. 6 shows a composite transformer core 60, wholly constructed by stacking and interleaving stamped “E” and “I” principal magnetic Lams 40 in FIG. 4. The stacking is composed of a 50/50 mix of the principal magnetics 117 used for its “E” shaped element 112, and principal magnetics 118 used for its “I” shaped element 113, and alternate magnetics 119 used for its “E” shaped element 112, and alternate magnetics 120 used for its “I” shaped element 113. The composite core construction of the core 60 illustrates reduced cost core construction of the same size and same power density as the conventional core 50 in FIG. 5. The 50/50 ratio would be achieved by having the stacking consist of 50% alternate magnetics 120, for its “E” shaped element 112 and alternate magnetics 119 for its “I” shaped element 113. The balance of the stacking, 50%, is the principal magnetics 117 for its “E”, 112, and principal magnetics 118 for its “I” shaped element 113. Preferably, the alternate magnetics 119 and 120 are the same grade of magnetic material of the same thickness 116 and are interlaced with the principal magnetics 117 and 118 also of the same thickness 116, so as to get the best heat distribution. The principal magnetic material 117 and the principal magnetic material 118 are the same magnetic materials.

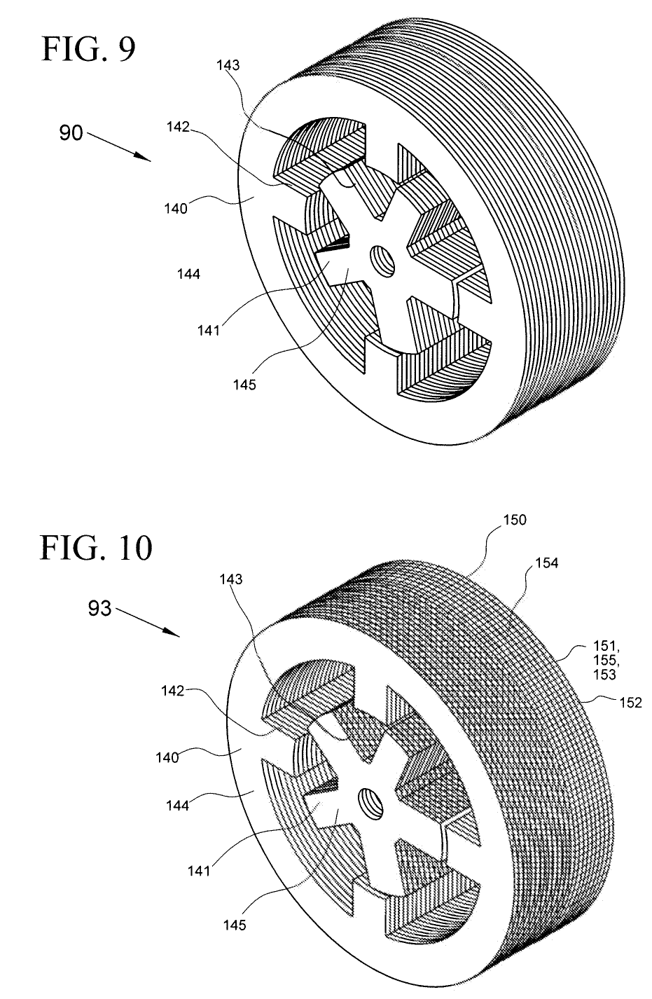

The interlace stacking as shown in FIG. 6 shows the principal magnetics 117 and 118, and alternate magnetics 119 and 120 alternating adjacent lamination positions with each other. Alternatively, the alternate magnetics 119 and 120 can be stacked in one section of the core while the principal magnetics 117 and 118 occupies the balance of the core. Separated stacking is demonstrated in composite stator rotor core assembly 90 in FIG. 9.

FIG. 7, composite core 70, show the “E” shaped elements 112 and the “I” shaped elements 113, stacked upon themselves thereby creating an interface seam 125 between the “E” and “I” stacks. The stacking and closing of the “E” and “I” shaped elements 112 and 113 is known as butt-stacking. The sections are usually fastened together by welding the sections along the length of the interface seam 125. This composite core construction 70 illustrates reduced cost core construction of the same size and same power density as conventional core 50 in FIG. 5.

Similar to the composite core 60 in FIG. 6, the lamination stacking as shown by the composite butt stacked core 70 in FIG. 7, shows the principal magnetics 117 and 118 and alternate magnetics 119 and 120 alternating adjacent lamination positions with each other. Alternatively, the principal magnetics 117 and 118 may be stacked in one section of the core while the alternate magnetics 119 and 120 occupy the balance of the core. Welded butt-stacking is a laminated core assembly technique that offers the advantage of integrating the principal magnetics 117 and 118, and the alternate magnetics 119 and 120 of different thicknesses.

FIG. 8 shows a lamination 80 consisting of a stamped stator Lam 140 made out of a magnetic material 144 with a thickness 142 and a stamped rotor Lam 141 made out of a magnetic material 145 with a thickness 143. The Stator 140 and rotor 141 form the lamination 80 that would be used to construct a motor or a generator. The lamination 80 is stamped from flattened lamination steel similar to the preparation of the transformer lamination 40 shown in FIG. 4.

A conventional motor-generator core 90 shown in FIG. 9 is built by assembling and stacking the conventional stator Lam 140 consisting of magnetics 144 with a thickness 142 and a conventional rotor Lam 141 consisting of magnetics 145 with a thickness 143 as the lamination steel Lams 80 in FIG. 4. A conventional motor and generator stacking construction 90 shown in FIG. 9 is similar to stacking the transformer laminations 40 to build the conventional laminated transformer core 50 shown in FIG. 5. The stator Lam 140 and the rotor Lam 141 are all of the same magnetic material 144 and 145 respectively, and the same thickness 142 and 143.

A composite motor-generator core stacking construction 93, shown in FIG. 10, is similar to stacking composite laminations 40 to build a composite laminated transformer core 60, FIG. 6. The motor-generator core 93, FIG. 10, is constructed in two sections with principal magnetics 144 of thickness 142 for the stator Lam 140 and principal magnetics 145 of thickness 143 for the rotor Lam 141 occupying one section which is 50% of the motor-generator.

The alternate magnetics section makes up the balance or 50% of the motor-generator. The alternate magnetic section is made of alternate magnetic material 154 used in the stator Lam 150 of the thickness 152, and the alternate magnetic material 155 used in the rotor Lam 151 of thickness 153. The alternate magnetics rotor section 151 is laminar stacked with the principal magnetics rotor 141 and is hidden in the isometric view of FIG. 10. The principal magnetics stator 140 of thickness 142 and the principal magnetics rotor 141 of thickness 143 are usually the same magnetics material, usually CRML: M50, and the same thickness, typically 26 gauge, 0.0185 inches. The alternate magnetics stator 150 of thickness 152 and the alternate magnetics rotor 151 of thickness 153 are usually of the same magnetics material and the same thickness. The thickness of the alternate magnetics does not have to be the same as the principal magnetics. However, their shapes and geometry are usually the same. Sometimes permanent magnets occupy all or part of the stator or rotor. The composite core construction 93 illustrates reduced cost core construction of the same size and same power density as the conventional motor-generator core 90 in FIG. 9.

The volume of the composite motor-generator 93 shown in FIG. 10 is the same as the volume of the conventional motor-generator 90 in FIG. 9, and both operate at the same maximum voltage, V_{Mx}(f). Thus, the power densities of the conventional motor-generator 90 in FIG. 9 are the same as the power density of the composite motor-generator 93 in FIG. 10.

The preferable composite motor-generator core stacking would be similar to the stacking of the transformer composite core 60 shown in FIG. 6 where the alternate magnetic material occupies every other lamination space so as to give the best heat dissipation for the core. To clarify the two composite core stackings, the composite motor and generator core stacking 93 in FIG. 10 is shown stacked in two separate sections instead of sequentially alternated as shown for the composite transformer cores 60 in FIGS. 6, and 70 in FIG. 7.

### Solid Block Cores (SBC)

Ferrite and powdered iron solid block cores, SBCs, may be used to construct composite cores. Ferrite and powdered iron SBCs come in toroidal or “E” shapes. Some manufacturers have used toroidal ferrite and powdered iron to construct composite SBC product offerings. These products are combinations of ferrite and powdered iron sections and are usually used for special inductive filters and rarely used for power transformer, inductor, or motor generator cores. The problem with commercial composite powdered iron and ferrite is that the powdered iron dominates the core volume and has a much higher dissipation than the ferrite and can cause damaging heat rise. Essentially, powdered iron is used as the principal magnetics while the ferrite is used as the alternate magnetics.

The preferred composite core embodiment for SBCs would use the ferrite as the principle magnetics and the powdered iron as the alternate magnetics. The powdered iron could also be used favorably with the flux redistribution technology of patent application Ser. No. 11/486,318 filed Jul. 13, 2006 to the same inventor which is hereby incorporated by reference.

The composite TWC constructions shown in FIGS. 2 and 3 would serve as construction guidelines for building composite toroidal solid block cores, (SBC)s. Referencing FIG. 2, a planar concentric toroidal composite SBC can be formed by using an SBC principal magnetic toroid for the inner section 100 and an acceptable concentric SBC alternate toroid for the outer section 105. Similarly, using FIG. 3 as a construction guideline, a toroidal composite SBC could be formed by concentrically stacking the principal toroidal SBC 100 with the alternate toroidal SBC 105.

Ferrite and powdered iron also come as “E” shaped SBCs. A composite “E-E” shaped SBC is best implemented sectionally instead of as individual interleaved layers as shown by the laminar composite E-I cores in FIGS. 6 and 7. Principal magnetics would occupy one section and the alternate magnetics would occupy the other section. The sectional construction is best described by the stator-rotor sectioning shown in the motor-generator composite core 93 in FIG. 10.

### Air Core (AiC)

Air or dielectric core (AiC) construction may be used as an alternate magnetic core in conjunction with an appropriate principal magnetic steel or ferrite core.

### Principal of Operation

Composite Core with High Residual Inductance Above Saturation

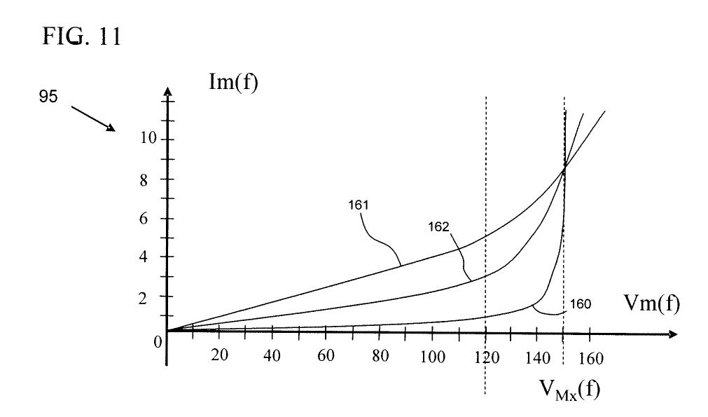

The composite core's principal of operation will be described by the core's rms magnetizing current, Im(f), response to the application of an rms operating voltage, Vm(f), to the core. FIG. 11 shows a composite graph 95 which illustrates the rms magnetizing current, Im(f), response to the rms operating voltage, Vm(f), applied to three different magnetic core constructions each of the same size and same magnetic windings.

First, the principal of operation of a conventional core and coil system fully and uniformly implemented with principal magnetic material M6 will be described as a basis of reference. The rms magnetizing current, Im(f), vs. the rms operating voltage, Vm(f), of the core and coil system is shown as curve 160 in the graph 95 in FIG. 11.

Then the operation of a conventional core and coil system fully and uniformly implemented with an alternate magnetic material with high residual inductance above saturation will be described as the basis of reference for alternate core construction material. The rms magnetizing current, Im(f), vs. the rms operating voltage, Vm(f), of the alternate core construction material is shown as curve 161 in the graph 95 in FIG. 11.

Finally, the operation of a composite core and coil system using principal magnetics and alternate magnetics with high residual inductance above saturation will be described. The composite core is a 50/50 material's ratio and will be used to illustrate that the composite core and coil construction is equivalent to the operation of a conventional core and coil system fully and uniformly implemented with principal magnetic material. The rms magnetizing current, Im(f), vs. the rms operating voltage, Vm(f) of the composite core and coil construction is shown as curve 162 in the graph 95 in FIG. 11. Both the composite core's curve 162 and the conventional core's curve 160 describe the magnetizing current's, Im(f), response to magnetizing voltage, Vm(f). The core sizes and magnetic windings for the magnetic constructions represented by curves 160, 161, and 162 are identical.

The example principal magnetics conventional core and coil system using is designed for a nominal operating voltage of 120 VAC, and an expected maximum operating voltage, V_{Mx}(f), nominally 150VAC. The rms magnetizing current, Im(f), vs. the rms operating voltage, Vm(f) of the principal magnetics conventional core and coil system is the curve 160 in graph 95 shown in FIG. 11. Above 150 VAC the principal magnetics' core is in hard saturation with a corresponding surge in magnetizing current, Im(f). Ideally the core is a constant valued inductance and experiences a rise in magnetizing current, Im(f), in the operating voltage, Vm(f), range of 0 VAC to 150 VAC that is directly proportional to the operating voltage, Vm(f). When the operating voltage, Vm(f) exceeds the designed peak operating voltage, V_{Mx}(f), 150VAC, the core is in hard saturation and the core's relative permeability (μ_{R}) has drastically reduced, approaching that of air. The magnetizing current, Im(f), now surges, as shown in curve 160 to much higher values limited only by the residual inductance of the core and wiring resistance.

A corresponding core and coil system fully using alternate magnetic material that would have a high residual inductance above saturation will experience similar magnetizing current, Im(f), behavior over the same operating voltage, Vm(f), region. The rms magnetizing current, Im(f), vs. the rms operating voltage, Vm(f) of the corresponding core and coil system using alternate magnetic material is the curve 161 shown in the graph 95 of FIG. 11. However, the magnetizing current, Im(f) for the alternate magnetic material will be two to three times as high as the magnetizing current for the principal magnetics because the permeability, t of the alternate magnetic material is half to a third of the principal magnetic material. Also, the conventionally designed alternate magnetic material core normally will require a cross sectional area that is about 35% bigger than the core and coil system constructed with the principal magnetic material because the nominal magnetic flux saturation of the principal magnetic material is about 25% more than the magnetic flux saturation of the alternate magnetic material. However, the curve 161 is based on an alternate magnetics core that is the same size and has the same magnetics winding as the cores used for the curves 160 and 162.

When the alternate magnetic material enters its saturation region the magnetizing current, Im(f), increase per volt over the saturation voltage, V_{Mx}(f), is 4 or 5 times less than the current increase of the principal magnetic material when its voltage exceeds V_{Mx}(f). In other words, the saturation region of the alternate magnetic material is a lot softer than that of the principal magnetic material. Consequently, the alternate magnetic material can be operated in its soft saturation region without the corresponding surge in its magnetizing current, Im(f), as would be experienced by the principal magnetic material. Also, the alternate magnetic material can be operated in its high residual induction region without heat increase and thereby effectively increase its operating induction to be comparable to that of the principal magnetic material. Furthermore, improved mill processing of alternate lamination steel can guarantee it to have a lower core dissipation than indicated by its “M” rating.

A composite core formed by the 50/50 ratio of principal to alternate magnetics has the magnetizing current, Im(f), vs. its operating voltage, Vm(f) graphically described by the curve 162 in the graph 95 of FIG. 11. In the region from 0 VAC to 120 VAC the high permeability region of both materials are working together cooperatively. The composite core has an effective permeability, μ_{eff}, about half that of the principal magnetics. Consequently, the composite core's magnetizing current, Im(f) will be higher than the magnetizing current, Im(f) for the principal magnetics in the 0 VAC to 120 VAC operating region, but lower than the magnetizing current, Im(f) for alternate magnetics in the 0 VAC to 120 VAC operating region. Above 120 VAC the composite core materials are begin to experience magnetic saturation. While the principal magnetics is significantly reducing its permeability, μ_{P}, the alternate magnetics permeability, μ_{A}, is only gradually reducing and thus keeps the magnetizing current from surging. The alternate magnetic material's high residual inductance above saturation limits the magnetizing current's increase. In fact, the magnetizing current rise from 120 VAC to 150 VAC and beyond is gradual without the characteristic magnetizing current surge of the saturated principal magnetic core due to the current limitation of the residual inductance of the alternate magnetic material.

Composite Core with Comparable Magnetics and Different Heat Dissipation

An alternative composite core can consist of two or more sets of magnetics without the need for a magnetic material with large residual inductance above saturation. An alternate composite core can consist of different magnetic materials with comparable magnetic characteristics and each with a different heat dissipation. The magnetic properties of the quality core grades, such as GO: M6; NGO: M19, and CRML: M50, are close to each other when they are gapped. Their principal differences are their heat dissipations. When a core design needs the benefit of a more expensive magnetic material requiring only a partial lower heat dissipation some of the core may be replaced by less expensive similar magnetics with higher heat dissipation. This combination effectively lowers the composite core cost, cost_{eff}, without sacrificing effective permeability, μ_{eff}, or effective saturation, Bsat_{eff} with only a nominal core temperature increase.

The various composite transformer and motor-generator cores are examples to illustrate the novel simple magnetic core construction modifications that may be used to convert conventional core designs to composite core. The composite core reduces the cost of equivalent sized conventional magnetic cores while maintaining or increasing the core's power density (PD). These transformer and motor-generator magnetic core construction modifications can be applied to any type of magnetic core in any Electro-magnetic or permanent magnetic device of any size. Further, the core construction modifications can be applied to devices operating from single phase, three-phase, or any poly-phase power supply.

The methods and devices described above for transformers and motor-generators may be generally applied to other Electro-magnetic and permanent magnetic devices such as inductors, solenoids, relays, and delay lines.

It will be apparent to those skilled in the art that various modifications and variations can be made to the various composite core combination methods and systems, described herein, without departing from the spirit or scope of the novelty. Thus, the various composite core constructions, described herein, are not limited by the foregoing descriptions but are intended to cover all modifications and variations that come within the scope of the spirit of the composite core construction schemes and the claims that follow.

What is claimed is:

1. A composite magnetic permeable core for an electromagnetic device, the composite core comprising:
a principal magnetic material having a first magnetic flux density saturation value; and
an alternate, different magnetic material having a second magnetic flux density saturation value lower than the first magnetic flux density saturation, wherein the core is operated at the first magnetic flux density saturation value.

2. The magnetic core of claim 1 wherein the principal magnetic material has a large residual inductance when the material is magnetically operated above the first magnetic flux density saturation, Bsat.

3. The magnetic core of claim 1 where the principal and alternate magnetic materials have different heat dissipations and similar magnetic properties.

4. The magnetic core of claim 1, wherein the principal and alternate magnetic materials are stacked in different magnetic laminations by either interleaving or butt stacking.

5. The magnetic core of claim 3 further comprising a gap in the principal and alternate magnetic materials and wherein the magnetic properties of the core are formed by varying the size of the gap.

6. The magnetic core of claim 3 wherein the magnetic properties of the core are formed by inducing bias currents through the principal and alternate magnetic materials.

7. The magnetic core of claim 4 formed by either interleaving or butt stacking different magnetic laminations such that the magnetic laminations either alternate lamination positions singularly or as a group.

8. The magnetic core of claim 1, wherein the core is formed by tape winding the different magnetic materials.

9. The magnetic core of claim 6, wherein the core is formed by either sequentially integrating the different magnetic materials into a continuous concentric tape winding or stacking the different tape wound cores such that they occupy a common center.

10. The magnetic core of claim 1, wherein the core is formed by solid block cores.

11. The magnetic core of claim 8, wherein the core is formed by either concentric placement of the different magnetic materials or by stacking the different magnetic materials in alignment one on top of the other.

12. A method of forming a composite magnetic permeable core for an electromagnetic device, the method comprising:
selecting a principal magnetic material having a first magnetic flux density saturation value;
selecting an alternate, different magnetic material having a second magnetic flux density saturation value lower than the first magnetic flux density saturation; and
joining the principal and alternate magnetic material such that the core is operated at the first magnetic flux density saturation value.

13. The method of claim 12, wherein the principal and alternate magnetic materials are stacked in different magnetic laminations by either interleaving or butt stacking.

14. The method of claim 12 further comprising forming a gap in the principal and alternate magnetic materials and forming the magnetic properties of the core by varying the size of the gap.

15. The method of claim 12, further comprising inducing bias currents through the principal and alternate magnetic materials to form the magnetic properties of the core.

16. The method of claim 12, wherein the different magnetic materials are joined via tape winding.

17. The method of claim 12, wherein the core is formed by solid block cores.

18. The method of claim 12, wherein the core is formed by concentric placement of the different magnetic materials or by stacking the different magnetic materials in alignment one on top of the other.
